(19) United States
(12) Patent Application Publication
(10) Pub. No.: US 2026/0269743 A1
(43) Pub. Date: Sep. 10, 2026

(54) FIVE-LEVEL OPERATION OF THREE-PHASE MATRIX DUAL ACTIVE BRIDGE

(71) Applicant: SEMICONDUCTOR COMPONENTS INDUSTRIES, LLC, Scottsdale, AZ (US)

(72) Inventor: Daniel Leon GOLDMANN, Munich (DE)

(73) Assignee: SEMICONDUCTOR COMPONENTS INDUSTRIES, LLC, Scottsdale, AZ (US)

(21) Appl. No.: 19/539,137

(22) Filed: Feb. 13, 2026

Related U.S. Application Data
(60) Provisional application No. 63/768,659, filed on Mar. 7, 2025.
(60) Provisional application No. 63/768,632, filed on Mar. 7, 2025.
(60) Provisional application No. 63/768,601, filed on Mar. 7, 2025.

(51) Int. Cl. H02M 7/483; H02M 7/00; H02M 7/217; H02M 7/219

(52) U.S. Cl. CPC H02M 7/4835; H02M 7/003; H02M 7/217; H02M 7/219

(57) ABSTRACT

A power converter includes an H-bridge coupled between a secondary side of the transformer and a battery, and a three-phase matrix bridge coupled between an AC voltage input and a primary side of the transformer. The three-phase matrix bridge includes first, second, and third phases coupled respectively between the transformer and an AC voltage input. The power converter further includes a control circuit that controls switching of the three-phase matrix bridge and the H-bridge. In response to a three-phase AC voltage at the AC voltage input, the control circuit applies a time-multiplexed switching pattern to switch the three-phase matrix bridge. In response to a single-phase AC voltage across a first-phase input and a second-phase input of the AC voltage input, the control circuit applies a single-phase switching pattern that operates the third phase as a T-type switch in conjunction with switching of the first phase and the second phase.

### PRIORITY

This application claims the benefit of U.S. Provisional Patent Application No. 63/768,601, filed Mar. 7, 2025, U.S. Provisional Patent Application No. 63/768,632, filed Mar. 7, 2025, and U.S. Provisional Patent Application No. 63/768,659, filed Mar. 7, 2025, which are each hereby incorporated by reference herein in their entirety.

### TECHNICAL FIELD

The disclosure relates generally to power electronics, and in particular to a three-phase matrix dual active bridge power converter.

### BACKGROUND

Power electronics may be used to control the conversion and distribution of electric power. For example, switching power converters may be used to create a direct current (“DC”) voltage from an alternating current (“AC”) voltage by switching current through a magnetic element such as transformer. Conversely, inverters may be used to convert a DC voltage to an AC voltage.

Isolated power converters may be used in a broad range of applications, including for example as a battery charger for an electric vehicle. Conventional on-board battery chargers may include an AC-DC stage to rectify a low frequency AC voltage from the power grid to produce a DC voltage across an electrolytic bulk capacitor. An isolated DC-to-DC converter stage may in turn be used to transfer power from the electrolytic bulk capacitor to the battery. For example, a high-frequency inverter may convert the DC voltage at the bulk capacitor into a high-frequency AC signal for transfer from the primary side to the secondary side of an isolation transformer. A high-frequency rectifier stage may in turn be coupled to the secondary side of the transformer to convert the high-frequency AC signal to a DC signal for charging the battery. The transformer may provide galvanic isolation between the grid and the battery for safety purposes. In turn, the use of high-frequency switching across the transformer may allow for higher power density and smaller magnetic components, which may be important factors for on-board chargers.

The inventor of embodiments of the present disclosure has recognized that such conventional on-board battery chargers may require the use of bulky components, such as the electrolytic bulk capacitor, that may increase the cost and the physical space required for the on-board battery charger. Matrix converters have been described in the field as a means for converting the low-frequency AC grid voltage directly to a high-frequency AC signal for transfer across the isolation transformer. Such use of a matrix converter may thus eliminate the need for the aforementioned electrolytic bulk capacitor used to store the intermediate DC voltage. However, the inventor of embodiments of the present disclosure has also recognized that various matrix converter topologies may have significant drawbacks. For example, indirect matrix converter topologies may have limited power capability (for example, less than 1 kW) due to parasitic inductances. Further, soft-switching solid state transformer converters (S4T converters) may suffer from large DC currents and reflected voltages across the transformer due to the operation of the transformer as a flyback device. As another example, known three-phase matrix topologies may involve complex modulation schemes, allowing for only one discontinuous modulation scheme and thereby resulting in large peak currents through the high-frequency transformer.

The inventor of embodiments of the present disclosure has also recognized that manufacturers of on-board battery chargers and/or manufacturers of electric vehicles including on-board battery chargers may benefit from a single design that may operate with both a three-phase AC power supply (utilized in Europe and China for example) and single-phase AC power supply (utilized in the United States for example). The inventor of embodiments of the present disclosure has also recognized that the configuration of conventional matrix-based converters optimized for operating with three-phase power may include inefficiencies if alternatively operated with single-phase power. Embodiments of the present disclosure may address one or more of these challenges.

### SUMMARY

The examples herein enable techniques for controlling the switching operation of a three-phase matrix dual active bridge converter.

According to one embodiment, a power converter includes (i) a transformer, (ii) an H-bridge coupled between a secondary side of the transformer and a battery, (iii) a three-phase matrix bridge coupled between an AC voltage input and a primary side of the transformer, the three-phase matrix bridge including a first phase, a second phase, and a third phase coupled respectively between the primary side of the transformer and a corresponding one of a first-phase input, a second-phase input, and a third-phase input of the AC voltage input, and (iv) a control circuit coupled to control switching of the three-phase matrix bridge and the H-bridge, the control circuit configured to, in response to a three-phase AC voltage at the first-phase input, the second-phase input, and the third-phase input of the AC voltage input, apply a time-multiplexed switching pattern to switch the three-phase matrix bridge, and in response to a single-phase AC voltage across the first-phase input and the second-phase input of the AC voltage input, apply a single-phase switching pattern that operates the third phase as a T-type switch in conjunction with switching of the first phase and the second phase of the three-phase matrix bridge. In some embodiments, the single-phase switching pattern is configured to apply any of five potential voltage levels across a primary winding of the transformer. In the same or different embodiments, the five potential voltage levels include a first voltage level equal to the single-phase AC voltage, a second voltage level equal to one-half of the single-phase AC voltage, a third voltage level equal to zero, a fourth voltage level equal to a negative one-half of the single-phase AC voltage, and a fifth voltage level equal to a negative of the single-phase AC voltage. In the same or different embodiments, the control circuit is configured to select one of a plurality of half-voltage modulation schemes to apply with the single-phase switching pattern based at least in part on a voltage level of the single-phase AC voltage. In the same or different embodiments, the time-multiplexed switching pattern alternates between a selected two of a first two-phase switching pattern that comprises switching the first phase and the second phase of the three-phase matrix bridge while disabling the third phase of the three-phase matrix bridge, a second two-phase switching pattern that comprises switching the first phase and the third phase of the three-phase matrix bridge while disabling the second phase of the three-phase matrix bridge, and a third two-phase switching pattern that comprises switching the second phase and the third phase of the three-phase matrix bridge while disabling the first phase of the three-phase matrix bridge. In the same or different embodiments, the control circuit is configured to determine the selected two of the first two-phase switching pattern, the second two-phase switching pattern, and the third two-phase switching pattern based at least in part on a first phase voltage, a second phase voltage, and a third phase voltage at the AC voltage input. In the same or different embodiments, the control circuit is configured to select one of a plurality of modulation schemes for each of the selected two of the of the first two-phase switching pattern, the second two-phase switching pattern, and the third two-phase switching pattern, based at least in part on a first phase voltage, a second phase voltage, and a third phase voltage at the AC voltage input. In the same or different embodiments, the control circuit is configured to detect whether the three-phase AC voltage or the single-phase AC voltage is present at the AC voltage input. In the same or different embodiments, the first phase of the three-phase matrix bridge is configured as a first bidirectional half-bridge between the first-phase input and the primary side of the transformer, the second phase of the three-phase matrix bridge is configured as a second bidirectional half-bridge between the first-phase input and the primary side of the transformer, and the third phase of the three-phase matrix bridge is configured as a third bidirectional half-bridge between the first-phase input and the primary side of the transformer. In the same or different embodiments, the H-bridge comprises a first switch coupled between a first terminal of a secondary winding of the transformer and a first terminal of the battery, a second switch coupled between the first terminal of the secondary winding of the transformer and a second terminal of the battery, a third switch coupled between a second terminal of the secondary winding of the transformer and the first terminal of the battery, and a fourth switch coupled between the second terminal of the secondary winding of the transformer and the second terminal of the battery.

According to another embodiment, three-phase matrix dual active bridge power converter includes (i) a transformer, (ii) an H-bridge coupled between a secondary side of the transformer and a battery, (iii) a three-phase matrix bridge including a first phase configured as a first bidirectional half-bridge between a first-phase input of an AC voltage input and the primary side of the transformer, a second phase configured as a second bidirectional half-bridge between a second-phase input of the AC voltage input and the primary side of the transformer, and a third phase configured as a third bidirectional half-bridge between a third-phase input of the AC voltage input and the primary side of the transformer, and (iv) a control circuit coupled to control switching of the three-phase matrix bridge and the H-bridge, the control circuit configured to detect whether a three-phase AC voltage is present at the AC voltage input or a single-phase AC voltage is present across the first-phase input and the second-phase input of the AC voltage input, and configured to, in response to the three-phase AC voltage at the first-phase input, the second-phase input, and the third-phase input of the AC voltage input, apply a time-multiplexed switching pattern to switch the three-phase matrix bridge, and in response to the single-phase AC voltage across the first-phase input and the second-phase input of the AC voltage input, apply a single-phase switching pattern that operates the third phase as a T-type switch in conjunction with switching of the first phase and the second phase of the three-phase matrix bridge. In some embodiments, the single-phase switching pattern is configured to apply any of five potential voltage levels across a primary winding of the transformer, the five potential voltage levels including a first voltage level equal to the single-phase AC voltage, a second voltage level equal to one-half of the single-phase AC voltage, a third voltage level equal to zero, a fourth voltage level equal to a negative one-half of the single-phase AC voltage, and a fifth voltage level equal to a negative of the single-phase AC voltage.

Another example provides a method for operating a three-phase matrix dual active bridge power converter, wherein the method includes (i) receiving an AC voltage at an AC voltage input that has a first-phase input, a second-phase input, and a third-phase input respectively coupled to a first phase, a second phase, and a third phase of a three-phase matrix bridge, (ii) selecting a time-multiplexed switching pattern if the AC voltage is a three-phase AC voltage, (iii) selecting a single-phase switching pattern if the AC voltage is a single-phase AC voltage, wherein the single-phase switching pattern is configured to operate the third phase as a T-type switch in conjunction with switching of the first phase and the second phase, (iv) switching the three-phase matrix bridge according to a selected one of the time-multiplexed switching pattern and the single-phase switching pattern, and (v) switching an H-bridge that is coupled between a secondary side of the transformer and a battery. In some embodiments, the single-phase switching pattern is configured to apply any of five potential voltage levels across a primary winding of the transformer, the five potential voltage levels including a first voltage level equal to the single-phase AC voltage, a second voltage level equal to one-half of the single-phase AC voltage, a third voltage level equal to zero, a fourth voltage level equal to a negative one-half of the single-phase AC voltage, and a fifth voltage level equal to a negative of the single-phase AC voltage. In some embodiments, the method further includes selecting one of a plurality of half-voltage modulation schemes to apply with the single-phase switching pattern based at least in part on a voltage level of the single-phase AC voltage. In some embodiments, the time-multiplexed switching pattern alternates between a selected two of (i) a first two-phase switching pattern that comprises switching the first phase and the second phase of the three-phase matrix bridge while disabling the third phase of the three-phase matrix bridge, (ii) a second two-phase switching pattern that comprises switching the first phase and the third phase of the three-phase matrix bridge while disabling the second phase of the three-phase matrix bridge, and (iii) a third two-phase switching pattern that comprises switching the second phase and the third phase of the three-phase matrix bridge while disabling the first phase of the three-phase matrix bridge. In the same or different embodiments, the method further includes determining the selected two of the first two-phase switching pattern, the second two-phase switching pattern, and the third two-phase switching pattern based at least in part on a first phase voltage, a second phase voltage, and a third phase voltage of the three-phase AC voltage at the AC voltage input. In the same or different embodiments, the method further includes selecting one of a plurality of modulation schemes for each of the selected two of the of the first two-phase switching pattern, the second two-phase switching pattern, and the third two-phase switching pattern, based at least in part on the first phase voltage, the second phase voltage, and the third phase voltage of the three-phase AC voltage at the AC voltage input. In the same or different embodiments, the method further includes coupling a three-phase supply to the first-phase input, the second-phase input, and the third-phase input of the AC voltage input. In the same or different embodiments, the method further includes coupling a single-phase supply across the first-phase input and the second-phase input of the AC voltage input.

### BRIEF DESCRIPTION OF THE DRAWINGS

A more complete understanding of the present embodiments may be acquired by referring to the following description taken in conjunction with the accompanying drawings, in which like reference numbers indicate like features.

FIG. 1A illustrates a schematic diagram of an interface between a three-phase AC supply and a power converter in accordance with embodiments of the present disclosure.

FIG. 1B illustrates a schematic diagram of an interface between a single-phase AC supply and a power converter in accordance with embodiments of the present disclosure.

FIG. 1C illustrates a schematic diagram of a power converter in accordance with embodiments of the present disclosure.

FIG. 2 illustrates a simplified schematic diagram of a power converter during a discrete period of operation with a three-phase AC supply in accordance with embodiments of the present disclosure.

FIG. 3A illustrates waveforms within a power converter in accordance with embodiments of the present disclosure.

FIG. 3B illustrates waveforms within a power converter in accordance with embodiments of the present disclosure.

FIG. 4 illustrates waveforms within a power converter in accordance with embodiments of the present disclosure.

FIG. 5A illustrates waveforms within a power converter in accordance with embodiments of the present disclosure.

FIG. 5B illustrates waveforms within a power converter in accordance with embodiments of the present disclosure.

FIG. 6A illustrates waveforms within a power converter in accordance with embodiments of the present disclosure.

FIG. 6B illustrates waveforms within a power converter in accordance with embodiments of the present disclosure.

FIG. 7A illustrates a simplified schematic diagram of a power converter during a discrete period of operation with a single-phase AC supply in accordance with embodiments of the present disclosure.

FIG. 7B illustrates a table listing control signal states for a three-phase matrix bridge to apply five levels of voltages during operation with a single-phase AC supply in accordance with embodiments of the present disclosure.

FIG. 8A illustrates a modulation-scheme map for operation of a power converter with a three-phase AC supply in accordance with embodiments of the present disclosure.

FIG. 8B illustrates a modulation-scheme map for operation of a power converter with a single-phase AC supply in accordance with embodiments of the present disclosure.

FIG. 9 illustrates an example method of operating a power converter in accordance with embodiments of the present disclosure.

### DETAILED DESCRIPTION

Details of one or more embodiments are set forth in the description below and the accompanying drawings. Other features will be apparent from the description, drawings, and from the claims. The embodiments disclosed should not be interpreted, or otherwise used, as limiting the scope of the disclosure, including the claims. In addition, one skilled in the art understands that the following description has broad application, and the discussion of any embodiment is meant to be exemplary of that embodiment, and not intended to intimate that the scope of the disclosure, including the claims, is limited to that embodiment.

Various terms are used to refer to particular system components. Different companies may refer to a component by different names, and this disclosure does not intend to distinguish between components that differ in name but not form and function. In the following discussion and in the claims, the terms “including” and “comprising” are used in an open-ended fashion, and thus should be interpreted to mean “including, but not limited to.” Also, the term “couple” or “coupled” is intended to mean either an indirect or direct connection. Thus, if a first device couples to, or is coupled to, a second device, that connection between the first device and the second device may be through a direct connection or through an indirect connection via other devices and connections. As used herein, the term “and/or” includes any and all combinations of one or more of the associated listed items.

Further, although the terms “first,” “second,” “third,” and so forth may be used herein to describe various elements, these elements should not be limited by these terms. Terms such as “first,” “second,” and “third” may be used merely to distinguish one element from another. For example, a first element could be termed a second element, and, similarly, a second element could be termed a first element, without departing from the scope of the present disclosure. Further, the identification of a “first” element, does not necessarily require the presence of a “second” element.

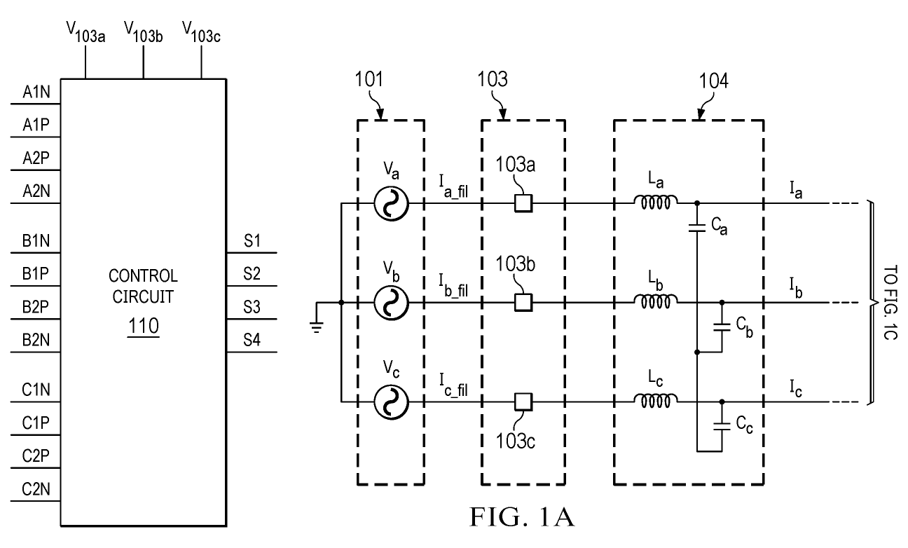

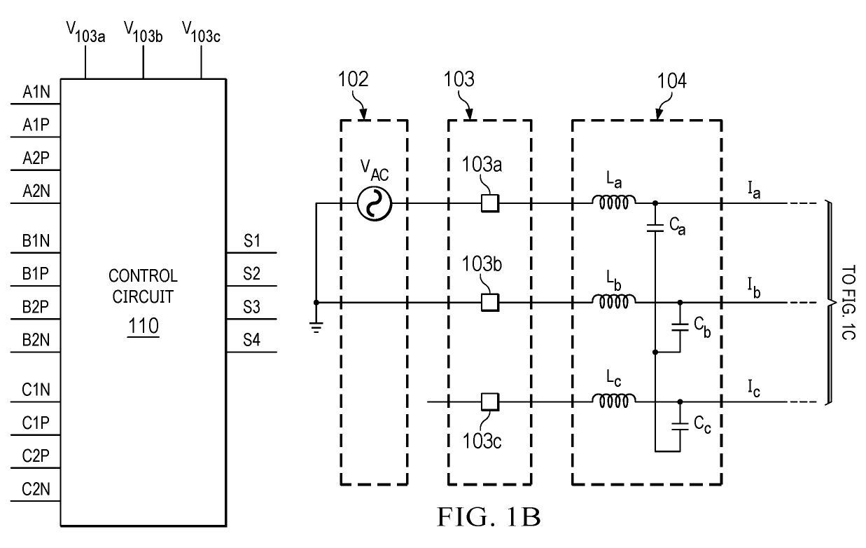

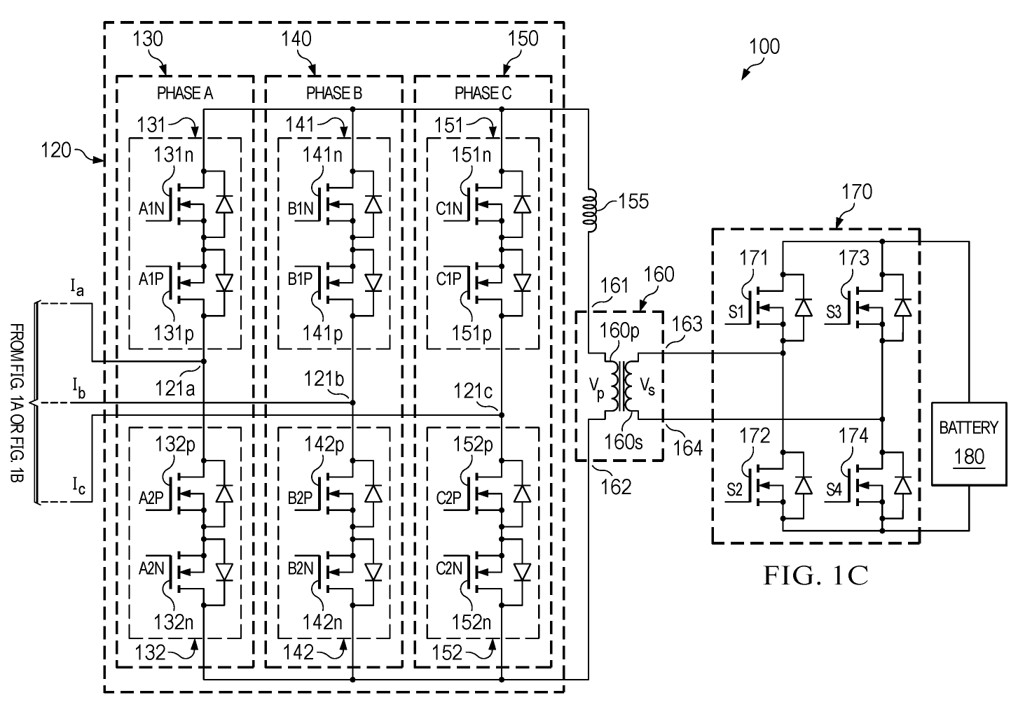

FIGS. 1A-1C collectively illustrate a schematic diagram of a power converter 100 that may optionally be coupled to a single-phase AC supply or a three-phase AC supply in accordance with embodiments of the present disclosure. Specifically, FIG. 1A illustrates an interface between three-phase AC supply 101 and power converter 100, while FIG. 1B illustrates an interface between single-phase AC supply 102 and power converter 100. In turn, FIG. 1C illustrates various components of power converter 100 that may be utilized to convert the three-phase or single-phase AC power into DC power for charging battery 180.

In some embodiments, power converter 100 may include AC voltage input 103, filter 104, and control circuit 110 (shown in both FIG. 1A and FIG. 1B), as well as three-phase matrix bridge 120, inductance 155, transformer 160, and H-bridge 170 (shown in FIG. 1C). As shown in FIG. 1C, three-phase matrix bridge 120 and H-bridge 170 may be coupled on opposing sides of transformer 160 and may be actively controlled by control circuit 110. Thus, for the purposes of the present disclosure, power converter 100 may also be referred to as a three-phase matrix dual active bridge converter. As described in further detail below, control circuit 110 may apply various switching patterns for three-phase matrix bridge 120 and H-bridge 170 depending in part on whether the AC voltage received at AC voltage input 103 is a three-phase AC voltage or a single-phase AC voltage.

As shown in FIG. 1A, AC voltage input 103 may be configured to receive a three-phase AC voltage from three-phase AC supply 101. In some embodiments, three-phase AC supply 101 may represent a three-phase grid supply, for example as commonly available in Europe and/or China. AC voltage input 103 may be configured to receive a first phase voltage Va at a first-phase input 103a, to receive a second phase voltage Vb at a second-phase input 103b, and to receive a third phase voltage Vc at a third-phase input 103c.

As shown in FIG. 1B, AC voltage input 103 may also be configured to alternatively receive a single-phase AC voltage (V_{AC}) from single-phase AC supply 102. In some embodiments, single-phase AC supply 102 may represent a single-phase grid supply, for example as commonly available in the United States. AC voltage input 103 may be configured to receive a single-phase AC voltage V_{AC} across the first-phase input 103a and the second-phase input 103b, while the third-phase input 103c is left open. As described in further detail below, third phase 150 of three-phase matrix bridge 120 may be operated as part of a T-type switch under such conditions, allowing the three-phase matrix bridge 120 to apply full or half-voltages of the single-phase AC voltage (V_{AC}) across the primary side of transformer 160.

As shown in FIGS. 1A and 1B, control circuit 110 may be configured to receive voltage inputs V₁₀₃ₐ, V_{103b}, and V_{103c}, representative of the voltages received at the first-phase input 103a, the second-phase input 103b, and the third-phase input 103c. Thus, in some embodiments, control circuit may assess the relative phases of V₁₀₃ₐ, V_{103b}, V_{103c} to detect whether the AC voltage at AC voltage input 103 is a single-phase AC voltage or a three-phase AC voltage. In other embodiments, control circuit 110 may utilize other means to detect whether the AC voltage at AC voltage input 103 is a single-phase AC voltage or a three-phase AC voltage. For example, control circuit 110 may include an additional input configured to receive a control signal (for example, from a user or from a plug by which the single-phase or three-phase supply is physically coupled to AC voltage input 103) indicating whether the AC voltage at AC voltage input 103 is a single-phase AC voltage or a three-phase AC voltage. And as described below, control circuit 110 may control the switching of three-phase matrix bridge 120 and H-bridge 170 based at least in part on whether the AC voltage received at AC voltage input 103 is a three-phase AC voltage or a single-phase AC voltage.

Filter 104 may be coupled between AC voltage input 103 and three-phase matrix bridge 120. Filter 104 may be configured to filter the voltages provided by, and the currents drawn from or supplied to, three-phase AC supply 101 or single-phase AC supply 102. For example, filter 104 may include a first inductor Lₐ and a first capacitor Cₐ configured as an LC filter coupled between first-phase input 103a and a first phase 130 of three-phase matrix bridge 120, a second inductor L_{b} and a second capacitor C_{b} configured as an LC filter coupled between second-phase input 103b and a second phase 140 of three-phase matrix bridge 120, and a third inductor L_{c} and a third capacitor C_{c} configured as an LC filter coupled between third-phase input 103c and a third phase 150 of three-phase matrix bridge 120.

Three-phase matrix bridge 120 may be coupled between the AC voltage input 103 and the primary side of transformer 160. As shown in FIG. 1C, three-phase matrix bridge 120 may include first phase 130, second phase 140, and third phase 150. First phase 130 may be coupled at node 121a to first-phase input 103a via filter 104. Second phase 140 may be coupled at node 121b to second-phase input 103b via filter 104. And third phase 150 may be coupled at node 121c to third-phase input 103c via filter 104.

As described directly below, each of first phase 130, second phase 140, and third phase 150 may include a first bidirectional switch coupled between a first terminal 161 of a primary winding 160p of transformer 160 and a respective one of the first-phase input 103a, second-phase input 103b, and third-phase input 103c of AC voltage input 103, and may also include a second bidirectional switch coupled between a second terminal 162 of the primary winding 160p of transformer 160 and a respective one of the first-phase input 103a, second-phase input 103b, and third-phase input 103c of AC voltage input 103.

First phase 130 (also labeled as PHASE A in FIG. 1C) may be configured as a first bidirectional half-bridge between the AC voltage input 103 and the primary side of transformer 160. For example, first phase 130 may include a first bidirectional switch 131 coupled in series with inductance 155 between first terminal 161 of primary winding 160p and node 121a, which in turn may be coupled via filter 104 to first-phase input 103a. First phase 130 may also include a second bidirectional switch 132 coupled between second terminal 162 of primary winding 160p and node 121a. In some embodiments, first bidirectional switch 131 may include a first transistor 131n coupled in series with a second transistor 131p, which may be driven at their respective gates by control signals A1N and A1P from control circuit 110. Similarly, second bidirectional switch 132 may include a first transistor 132n coupled in series with a second transistor 132p, which may be driven at their respective gates by control signals A2N and A2P from control circuit 110. As shown in FIG. 1C, the respective first and second transistors of first bidirectional switch 131 and second bidirectional switch 132 may be coupled in series in a back-to-back configuration relative to each other (for example, with their respective sources coupled together) to block any unintended conduction path through the respective body diodes of those first and second transistors of first bidirectional switch 131 and second bidirectional switch 132.

Second phase 140 (also labeled as PHASE B in FIG. 1C) may be configured as a second bidirectional half-bridge between the AC voltage input 103 and the primary side of transformer 160. For example, second phase 140 may include a first bidirectional switch 141 coupled in series with inductance 155 between first terminal 161 of primary winding 160p and node 121b, which in turn may be coupled via filter 104 to second-phase input 103b. Second phase 140 may also include a second bidirectional switch 142 coupled between second terminal 162 of primary winding 160p and node 121b. In some embodiments, first bidirectional switch 141 may include a first transistor 141n coupled in series with a second transistor 141p, which may be driven at their respective gates by control signals B1N and B1P from control circuit 110. Similarly, second bidirectional switch 142 may include a first transistor 142n coupled in series with a second transistor 142p, which may be driven at their respective gates by control signals B2N and B2P from control circuit 110. As shown in FIG. 1C, the respective first and second transistors of first bidirectional switch 141 and second bidirectional switch 142 may be coupled in series in a back-to-back configuration relative to each other (for example, with their respective sources coupled together) to block any unintended conduction path through the respective body diodes of those first and second transistors of first bidirectional switch 141 and second bidirectional switch 142.

Third phase 150 (also labeled as PHASE C in FIG. 1C) may be configured as a third bidirectional half-bridge between the AC voltage input 103 and the primary side of transformer 160. For example, third phase 150 may include a first bidirectional switch 151 coupled in series with inductance 155 between first terminal 161 of primary winding 160p and node 121c, which in turn may be coupled via filter 104 to third-phase input 103c. Third phase 150 may also include a second bidirectional switch 152 coupled between second terminal 162 of primary winding 160p and node 121c. In some embodiments, first bidirectional switch 151 may include a first transistor 151n coupled in series with a second transistor 151p, which may be driven at their respective gates by control signals C1N and C1P from control circuit 110. Similarly, second bidirectional switch 152 may include a first transistor 152n coupled in series with a second transistor 152p, which may be driven at their respective gates by control signals C2N and C2P from control circuit 110. As shown in FIG. 1C, the respective first and second transistors of first bidirectional switch 151 and second bidirectional switch 152 may be coupled in series in a back-to-back configuration relative to each other (for example, with their respective sources coupled together) to block any unintended conduction path through the respective body diodes of those first and second transistors of first bidirectional switch 151 and second bidirectional switch 152.

H-bridge 170 may be coupled between a secondary side of transformer 160 and battery 180. For example, H-bridge 170 may include first switch 171, second switch 172, third switch 173, and fourth switch 174. First switch 171 may be coupled between a first terminal 163 of a secondary winding 160s of transformer 160 and a first terminal of battery 180. Second switch 172 may be coupled between the first terminal 163 of secondary winding 160s of transformer 160 and a second terminal of battery 180. Third switch 173 may be coupled between a second terminal 164 of secondary winding 160s of transformer 160 and the first terminal of battery 180. And fourth switch 174 may be coupled between the second terminal 164 of secondary winding 160s of transformer 160 and the second terminal of battery 180. As shown in FIG. 1C, first switch 171, second switch 172, third switch 173, and fourth switch 174 may be coupled to be driven at their respective gates by respective control signals S1, S2, S3, and S4 from control circuit 110.

In some embodiments, such as shown in FIG. 1C, the various switches that form three-phase matrix bridge 120 and H-bridge 170 may be implemented with for example, n-channel metal-oxide semiconductor field effect transistors (“n-channel MOSFETs” or “NMOS transistors”). In other embodiments, the various switches that form three-phase matrix bridge 120 and H-bridge 170 may be implemented with integrated-gate bi-polar transistors (“IGBTs”), or any other type of transistor suitable to handle the high voltages and currents of the application in which power converter 100 is implemented. In some embodiments, the various switches that form three-phase matrix bridge 120 and H-bridge 170 may be implemented with silicon carbide transistors, such as silicon carbide NMOS transistors or silicon carbide IGBTs. The various switches that form three-phase matrix bridge 120 and H-bridge 170 may also be formed by silicon transistors, or transistors formed on any other type of semiconductor substrate suitable to handle the high currents and high voltages of the application in which power converter 100 is implemented.

Control circuit 110 may be coupled to control switching of three-phase matrix bridge 120 and H-bridge 170. As shown in FIGS. 1A-1C, control circuit 110 may output various control signals to control the switching on and off of the various transistors that form three-phase matrix bridge 120 and H-bridge 170. Specifically, control circuit 110 may be configured to control switching of three-phase matrix bridge 120 and H-bridge 170 to regulate a flow of power from AC voltage input 103 to the battery 180 that is coupled to H-bridge 170. For example, three-phase matrix bridge 120 may be controlled to convert a low-frequency AC input from three-phase AC supply 101 into a high-frequency AC signal that is transmitted across transformer 160 (from the primary side to the secondary side) and rectified by the controlled switching of H-bridge 170 to provide DC power to charge battery 180.

In some embodiments, power converter 100 may be configured as a bidirectional power converter. Accordingly, control circuit 110 may also be configured to control switching of three-phase matrix bridge 120 and H-bridge 170 to regulate a flow of power from battery 180 to AC voltage input 103. During such operation, control circuit 110 may control the switching of H-bridge 170 to convert the DC voltage across battery 180 into a high-frequency AC signal that is transmitted across transformer 160 (from the secondary side to the primary side). During such operation, control circuit 110 may also control the switching of three-phase matrix bridge 120 to convert the high-frequency AC signal from transformer 160 into a low-frequency AC signal that may be placed back on the grid via AC voltage input 103.

As described above, control circuit 110 may be configured to detect whether the AC voltage at AC voltage input 103 is a single-phase AC voltage or a three-phase AC voltage. And as described below, control circuit 110 may control the switching of three-phase matrix bridge 120 and H-bridge 170 based at least in part on whether the AC voltage received at AC voltage input 103 is a three-phase AC voltage or a single-phase AC voltage.

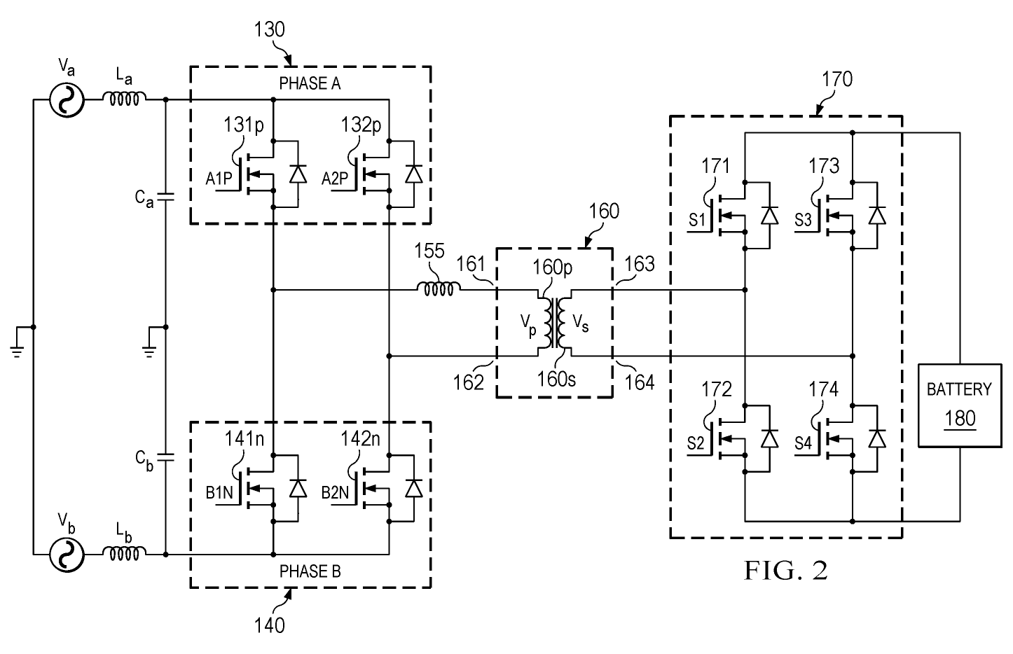

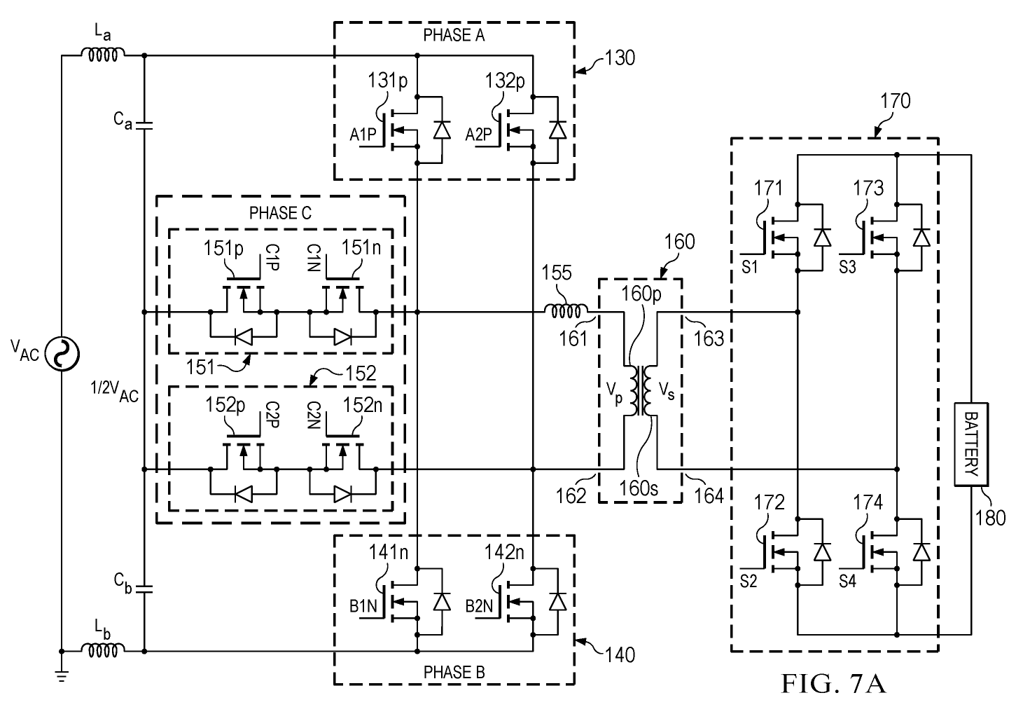

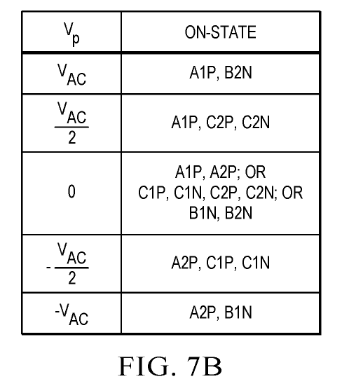

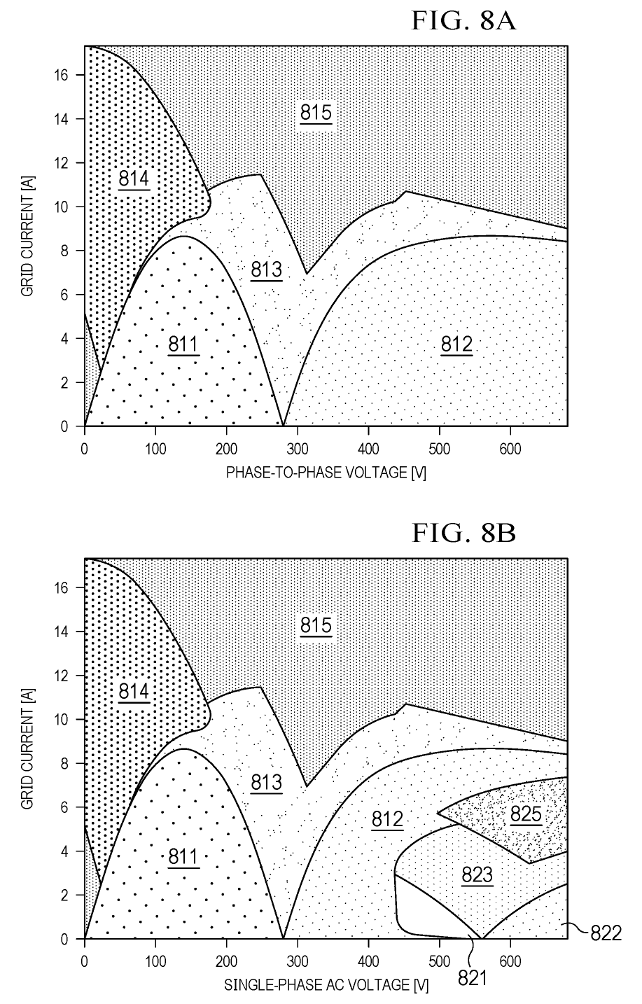

In some embodiments, control circuit 110 may apply different switching patterns to three-phase matrix bridge 120 (and H-bridge 170) depending on whether the AC voltage received at AC voltage input 103 is single-phase or three-phase. For example, in response to a three-phase AC voltage at the first-phase input 103a, the second-phase input 103b, and the third-phase input 103c of AC voltage input 103, control circuit 110 may apply a time-multiplexed switching pattern to switch three-phase matrix bridge 120 in conjunction with the switching of H-bridge 170 to regulate the flow of power between AC voltage input 103 and battery 180. And in response to a single-phase AC voltage across the first-phase input 103a and the second-phase input 103b of AC voltage input 103, control circuit 110 may apply a single-phase switching pattern that operates third phase 150 as a T-type switch in conjunction with switching of first phase 130 and second phase 140 of three-phase matrix bridge 120. By operating third phase 150 as a T-type switch, the single-phase switching pattern may apply any of five potential voltage levels across primary winding 160p of transformer 160. The operation of power converter 100 under conditions with a three-phase AC input is described in further detail below with reference to FIGS. 2-6B and 8A. Further, the operation of power converter 100 under conditions with a single-phase AC input is described in further detail below with reference to FIGS. 7A-7B and 8B.

The inventor of embodiments of the present disclosure has recognized that, under conditions with three-phase AC supply 101 coupled to AC voltage input 103, the control scheme for controlling the switching of three-phase matrix bridge 120 and H-bridge 170 may be significantly simplified by time-division multiplexing the switching control provided by control circuit 110. For example, in response to a three-phase AC voltage at the first-phase input 103a, the second-phase input 103b, and the third-phase input 103c of AC voltage input 103, control circuit 110 may apply a time-multiplexed switching pattern to switch three-phase matrix bridge 120 in conjunction with the switching of H-bridge 170. In some embodiments, the time-multiplexed switching pattern may alternate between a selected two of (i) a first two-phase switching pattern, (ii) a second two-phase switching pattern, and (iii) a third two-phase switching pattern, over the course of a macro-period.

Each two-phase switching pattern may involve actively switching a selected two out of three phases of three-phase matrix bridge 120 while disabling the other of the three phases. For example, the first two-phase switching pattern may comprise switching a first phase (for example, first phase 130) and a second phase (for example, second phase 140) of the three-phase matrix bridge 120 while disabling the third phase (for example, third phase 150) of the three-phase matrix bridge 120. The second two-phase switching pattern may comprise switching the first phase (for example, first phase 130) and the third phase (for example, third phase 150) of the three-phase matrix bridge 120 while disabling the second phase (for example, second phase 140) of the three-phase matrix bridge 120. The third two-phase switching pattern may comprise switching the second phase (for example, second phase 140) and the third phase (for example, third phase 150) of the three-phase matrix bridge 120 while disabling the first phase (for example, first phase 130) of the three-phase matrix bridge 120.

Control circuit 110 may monitor the voltages received at AC voltage input 103 from three-phase AC supply 101. For example, as shown in FIG. 1A, control circuit 110 may monitor the first phase voltage Va at a first-phase input 103a, the second phase voltage Vb at a second-phase input 103b, and the third phase voltage Vc at a third-phase input 103c. In some embodiments, control circuit 110 may determine the selected two of the first two-phase switching pattern, the second two-phase switching pattern, and the third two-phase switching pattern based at least in part on the first phase voltage (Va for example), the second phase voltage (Vb for example), and the third phase voltage (Vc for example) present at the AC voltage input 103. Further, control circuit 110 may be configured to change which two of the first, the second, and the third two-phase switching patterns comprise the selected two based at least in part on a change of the first phase voltage (Va for example), the second phase voltage (Vb for example), and the third phase voltage (Vc for example) present at the AC voltage input 103.

For example, over a course of a first macro-period (for example, 60µs), control circuit 110 may repeatedly alternate between micro-periods (for example, 6µs each) of a first two-phase switching pattern and a second two-phase switching pattern. Subsequently, as the phase voltages (Va, Vb, and Vc) change over time, control circuit 110 may change which two-phase switching patterns are utilized. Thus, over the course of a second macro-period (for example, 60µs) subsequent to the first macro-period, control circuit may repeatedly alternate between micro-periods (for example, 6µs each) of a third two-phase switching pattern and a selected one of the first two-phase switching pattern and the second t control circuit 110 may change which two-phase switching patterns are utilized. Thus, over the course of a second macro-period (for example, 60µs) subsequent to the first macro-period, control circuit may repeatedly alternate between micro-periods (for example, 6µs each) of a third two-phase switching pattern wo-phase switching pattern utilized during the first macro-period.

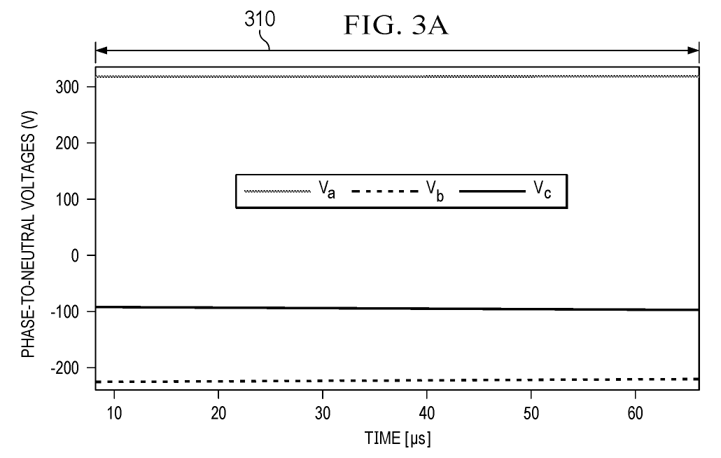

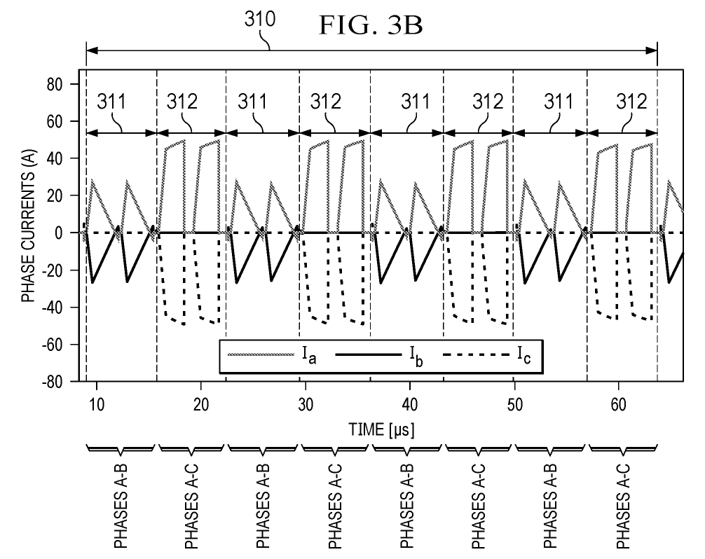

The three-phase AC voltage provided by three-phase AC supply 101 may have a low frequency of 50 Hz, for example. Given the low frequency, the three phase voltages (Va, Vb, and Vc) at AC voltage input 103 may have only a negligible change over the course of a macro-period and the repeated alternating micro-periods within any given macro-period. Accordingly, the control scheme for any given micro-period when operating with the above described time-multiplexed switching pattern may be simplified as described below with reference to FIGS. 2, 3A and 3B.

FIG. 2 illustrates a simplified schematic diagram of power converter 100 during a discrete period of operation in accordance with embodiments of the present disclosure. Specifically, FIG. 2 illustrates a simplified schematic diagram of power converter 100 during a first micro-period 311 within the macro-period 310 illustrated in FIG. 3A and FIG. 3B.

FIGS. 3A and 3B illustrate waveforms within power converter 100 in accordance with embodiments of the present disclosure. Specifically, FIG. 3A illustrates the levels of the first phase voltage Va, the second phase voltage Vb, and the third phase voltage Vc relative to neutral across macro-period 310. In turn, FIG. 3B illustrates the first phase-current Ia, the second phase current Ib, and the third phase current Ic, as control circuit 110 alternates between a first two-phase switching pattern during instances of first micro-period 311 and a second two-phase switching pattern during the instances of second micro-period 312 that are interleaved with the instances of first micro-period 311.

As shown in illustrative example of FIG. 3A, Va may be roughly +310 Volts, Vb may be roughly -215 Volts, and Vc may be roughly -95 Volts throughout macro-period 310. And as indicated by FIG. 3B, control circuit 110 may repeatedly alternate between a first two-phase switching pattern and a second two-phase switching pattern over the course of macro-period 310. For example, control circuit 110 may control three-phase matrix bridge 120 according to a first two-phase switching pattern (switching first phase 130 and second phase 140 while disabling third phase 150) during repeated instances of first micro-period 311. Control circuit may also control three-phase matrix bridge 120 according to a second two-phase switching pattern (switching first phase 130 and third phase 150 while disabling second phase 140) during repeated instances of second micro-period 312 that are interleaved with the repeated instances of first micro-period 311.

When operating with a two-phase switching pattern of any given micro-period, the circuit analysis and corresponding control scheme may be simplified for that micro-period. For example, during each instance of first micro-period 311 within macro-period 310, control circuit 110 may disable third phase 150 of three-phase matrix bridge 120 by driving each of first transistor 151n and second transistor 151p of first bidirectional switch 151, and first transistor 152n and second transistor 152p of second bidirectional switch 152, in respective off-states. Moreover, because Va is positive throughout first micro-period 311, first transistor 131n of first bidirectional switch 131 and first transistor 132n of second bidirectional switch 132 within first phase 130 may be held in respective on-states throughout first micro-period 311 to save switching losses as those transistors are not needed to selectively block or pass the positive voltage level of Va during first micro-period 311. Further, because Vb is negative throughout first micro-period 311, second transistor 141p of first bidirectional switch 141 and second transistor 142p of second bidirectional switch 142 within second phase 140 may be held in respective on-states throughout first micro-period 311 to save switching losses as those transistors are not needed to selectively block or pass the negative voltage level of Vb during first micro-period 311.

Under the above described conditions for the first two-phase switching pattern employed during first micro-period 311, the schematic diagram of power converter 100 may be simplified as shown in FIG. 2. For example, the second transistors 131p and 132p of first phase 130 (also labeled as PHASE A), combined with first transistors 141n and 142n of second phase 140 (also labeled as PHASE B), may form a simple H-bridge for applying the differential of the first phase voltage Va and the second phase voltage Vb across the primary winding 160p of transformer 160 (and inductance 155). Although FIG. 2 illustrates a simplified schematic specific to the first two-phase switching pattern employed during first micro-period 311, it is appreciated that the second two-phase switching pattern (employing first phase 130 and third phase 150 while disabling second phase 140) and the third two-phase switching pattern (employing second phase 140 and third phase 150 while disabling first phase 130) would result in simplified H-bridge configurations, similar to that shown in FIG. 2, for applying any selected two of Va, Vb, and Vc across the primary side of transformer 160.

As is appreciated in the art, the modulation schemes for such an H-bridge configuration at the primary side of a transformer in a dual active bridge converter may be less complex and more robust than modulation schemes for three-phase operation of a three-phase matrix bridge. Thus, the two-phase operation of three-phase matrix bridge 120 during any given micro-period may allow control circuit 110 to employ a broader range of modulation schemes for the selected two-phase switching pattern employed during that micro-period. For example, control circuit 110 may apply any of a triangular boost modulation scheme, a triangular buck modulation scheme, a trapezoidal modulation scheme, an extended phase shift modulation scheme, or a single phase shift modulation scheme, during a given micro-period, depending on status of the phase voltages and the current required by the application.

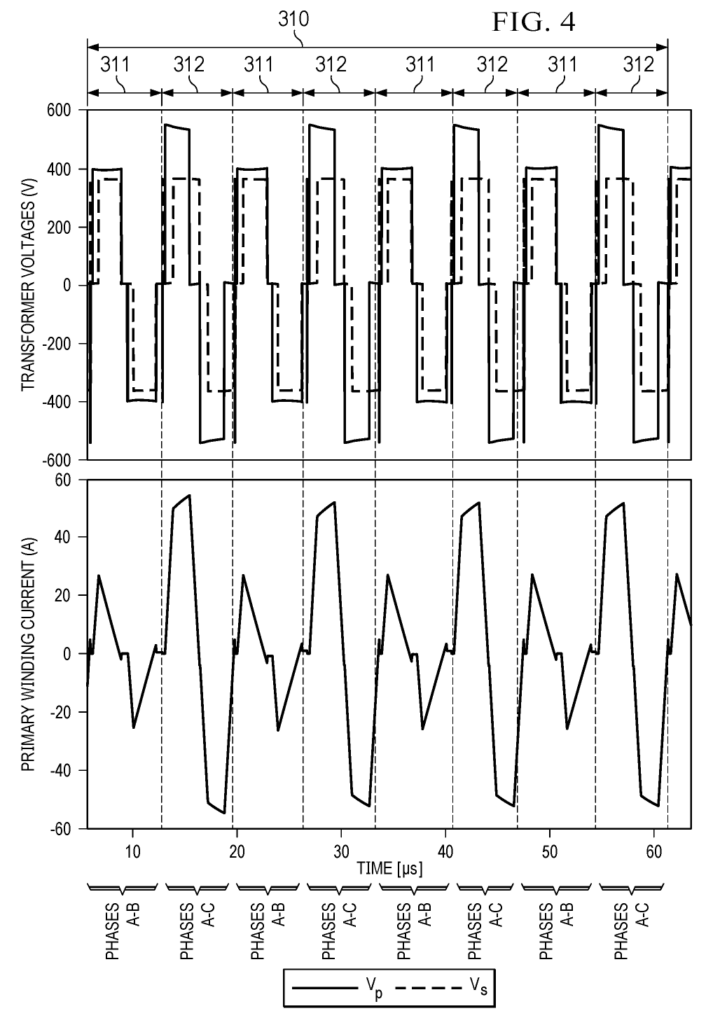

In some embodiments, the modulation scheme employed by the first two-phase switching pattern during instances of a first micro-period may be different than the modulation scheme employed by the second two-phase switching pattern during instances of a second micro-period that are interleaved with instances of the first micro-period. For example, as shown by the phase currents in FIG. 3B (and also by the primary winding current in FIG. 4), control circuit 110 may employ different modulation schemes for the alternating first two-phase switching pattern employed during instances of first micro-period 311 and the second two-phase switching pattern employed during instances of second micro-period 312. In the example illustrated in FIG. 3B (and also by the primary winding current in FIG. 4), control circuit 110 may control the switching of three-phase matrix bridge 120 and H-bridge 170 to employ a triangular modulation scheme with the first two-phase switching pattern during instances of first micro-period 311, and employ a trapezoidal modulation scheme with the second two-phase switching pattern during instances of second micro-period 312.

For the purposes of the present disclosure, a “two-phase switching pattern” may refer to which two of the three phases of three-phase matrix bridge may be employed during a given micro-period. The modulation scheme may in turn refer to the control of the on-times and off-times of the various switches within the selected two phases of the three-phase matrix bridge 120 in conjunction with the control of H-bridge 170, and the resulting shape of the currents that flow between the AC voltage input 103 and battery 180. The modulation schemes for first micro-period 311 and second micro-period 312 are described in further detail below with reference to FIG. 4 for example.

FIG. 4 illustrates waveforms within power converter 100 in accordance with embodiments of the present disclosure. Specifically, FIG. 4 illustrates the voltage (Vp) across the primary winding 160p of transformer 160, the voltage across the secondary winding 160s of transformer 160, and the primary winding current, as a result of the modulation schemes employed by the first two-phase switching pattern during instances of first micro-period 311 and the second two-phase switching pattern during instances of second micro-period 312.

During first micro-period 311, control circuit 110 may drive first phase 130 and second phase 140 to apply Vp across the primary winding 160p, and may drive H-bridge 170 to apply Vs across secondary winding 160s. The magnitudes and pulse-widths of the voltages applied across the primary and secondary windings of transformer 160 may induce a triangular shaped current through inductance 155 and the primary winding 160p of transformer 160 during each instance of first micro-period 311. During second micro-period 312, control circuit 110 may drive first phase 130 and third phase 150 to apply Vp across the primary winding 160p, and may drive H-bridge 170 to apply Vs across secondary winding 160s. The magnitudes and pulse-widths of the voltages applied across the primary and secondary windings of transformer 160 may induce a trapezoidal shaped current through inductance 155 and the primary winding 160p of transformer 160 during each instance of second micro-period 312.

In some embodiments, the modulation scheme employed by each of the selected two of the first, second, and third two-phase switching patterns may be determined based in part on the level of the corresponding phase voltages (Va, Vb, and Vc) across a given macro-period and the alternating micro-periods therein. For example, the pulse-widths of the voltages applied across the primary winding and the secondary winding (and the currents induced as a result thereof) for each micro-period may be controlled based on the corresponding two phase voltages (the corresponding two of Va, Vb, and Vc) for that micro-period. The modulation scheme for each micro-period may thus be optimized for the specific line to line voltage and current for the corresponding phases. Moreover, as shown in FIG. 4, short breaks may be included between the two modes of the alternating two-phase switching patterns. This may allow time for a change from one set of active phases to another set of active phases, and may also prevent the accumulation of flux in the transformer core.

As described above with reference to FIGS. 3A and 3B, the selection of the two out of the three possible two-phase switching patterns may be determined based in part on the phase voltages (Va, Vb, and Vc). In some embodiments, the phase requesting the most current may be operated continuously while the other two phases are discontinuous (thereby keeping transformer RMS current low). For example, during the macro-period 310 shown in FIGS. 3A and 3B, the first phase voltage Va may have a higher magnitude than the second phase voltage Vb and the third phase voltage Vc. To maintain a high power factor (with the respective phase currents linearly tracking the respective phase voltage), control circuit 110 may select the first and second two-phase switching patterns to alternate between during macro-period 310. Accordingly, first phase 130 (also labeled as PHASE A) may be switched throughout macro-period 310, while second phase 140 (also labeled as PHASE B) and third phase 150 (also labeled as PHASE C) are alternatively enabled and disabled during repeating instances of first micro-period 311 and second micro-period 312. The average of the first phase current Iₐ may thus be controlled to be higher than the respective averages of the second phase current I_{b} and the third phase current I_{c} during macro-period 310, thereby more closely corresponding to the higher phase voltage Va.

By operating the three-phase matrix bridge 120 according to the alternating two-phase switching patterns described herein, power converter 100 may individually set line-to-neutral currents for each of the first, second, and third phases, with their sum equaling zero. Accordingly, the transferred current for a given phase need not linearly track the AC voltage for that phase.

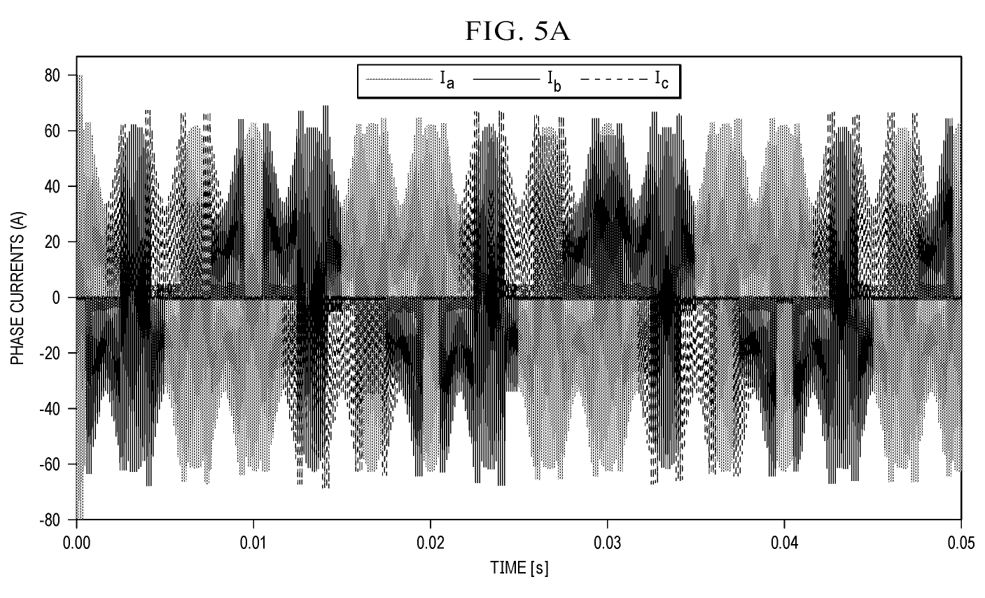

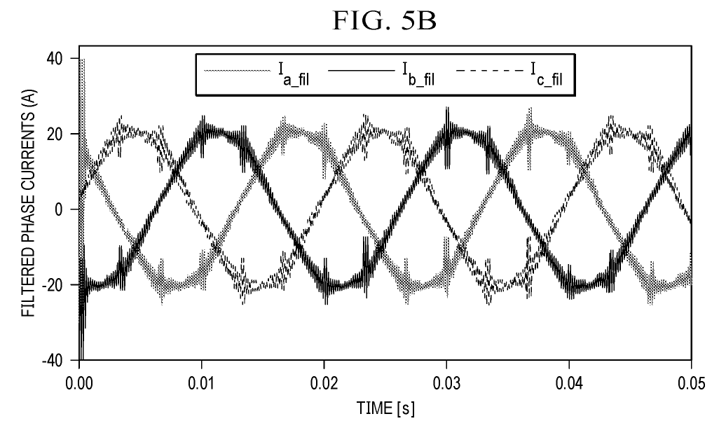

FIGS. 5A and 5B illustrate waveforms within power converter 100 in accordance with embodiments of the present disclosure. FIG. 5A illustrates the phase currents Iₐ, I_{b}, and I_{c} drawn by power converter 100 at the low-frequency AC side of three-phase matrix bridge 120 at a time scale corresponding to multiple cycles of first, second, and third phase voltages of three-phase AC supply 101. FIG. 5B illustrates the filtered phase currents I_{a_fil}, I_{b_fil}, and I_{c_fil} drawn by power converter 100 from AC voltage input 103 as filtered by filter 104.

As described above, by operating the three-phase matrix bridge 120 according to the alternating two-phase switching patterns described herein, power converter 100 may individually set line-to-neutral currents (corresponding to Iₐ, I_{b}, and I_{c}) for each of the first, second, and third phases, with their sum equaling zero. As the respective phase voltages vary up and down, the selected two of the three possible two-phase switching patterns may change across different macro-periods. Thus, the phase currents Iₐ, I_{b}, and I_{c} may be respectively controlled in a manner that is not necessarily sinusoidal and does not necessarily linearly track the corresponding phase voltages Va, Vb, and Vc during a given macro-period. Nonetheless, the respective averages of the phase currents Iₐ, I_{b}, and I_{c} may be controlled such that, when filtered by filter 104, those currents may have generally sinusoidal shapes that respectively track Va, Vb, and Vc. Filter 104 may have a cut-off frequency lower than a frequency at which control circuit 110 is configured to alternate between the selected two of the first two-phase switching pattern, the second two-phase switching pattern, and the third two-phase switching pattern. For example, in some embodiments, filter 104 may have a cut-off frequency of, for example 35 kHz. In other embodiments, the cut-off frequency of filter 104 may be any other frequency lower than the frequency at which control circuit 110 alternates between the selected two two-phase switching patterns. Accordingly, the respective averages of the phase currents Iₐ, I_{b}, and I_{c} may be controlled such that the filtered phase currents I_{a_fil}, I_{b_fil}, and I_{c_fil} may have generally sinusoidal shapes that respectively track the sinusoidal shapes of Va, Vb, and Vc. Power converter 100 may thus be operated with a high power factor if and where desired by the battery-charger application in which power converter 100 is implemented.

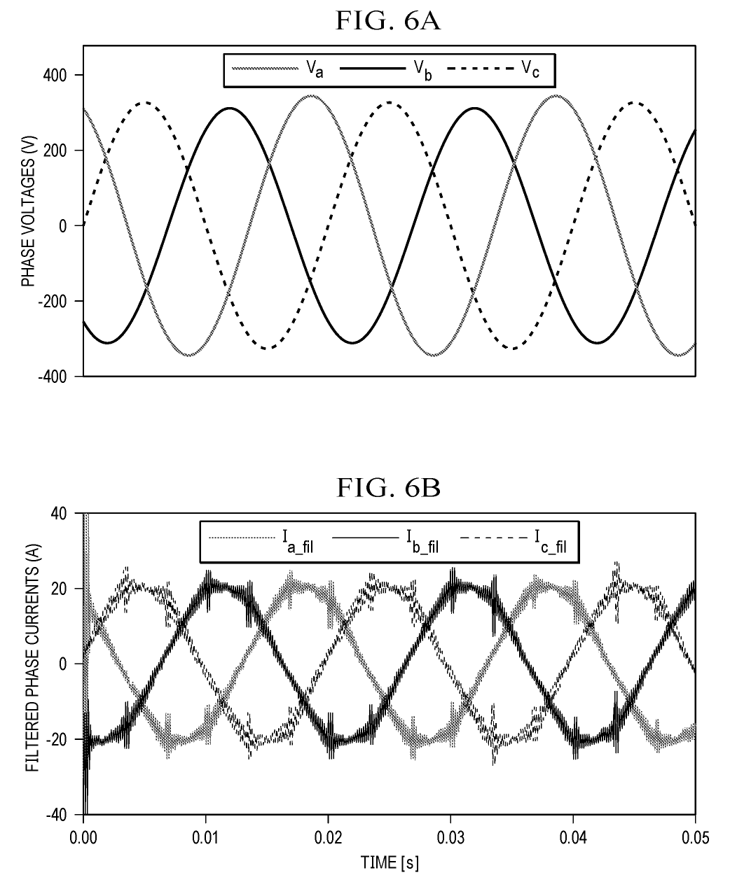

FIGS. 6A and 6B illustrate waveforms within power converter 100 in accordance with embodiments of the present disclosure. FIG. 6A illustrates a condition whereby the phase voltages Va, Vb, and Vc from three-phase AC supply 101 are unbalanced. FIG. 5B illustrates the filtered phase currents I_{a_fil}, I_{b_fil}, and I_{c_fil} drawn by power converter 100 from AC voltage input 103 as filtered by filter 104.

As described above, by operating the three-phase matrix bridge 120 according to the alternating two-phase switching patterns described herein, power converter 100 may individually set line-to-neutral currents (corresponding to Iₐ, I_{b}, and I_{c}) for each of the first, second, and third phases, with their sum equaling zero. As the respective phase voltages vary up and down, the selected two of the three possible two-phase switching patterns may change across different macro-periods. Thus, the phase currents Iₐ, I_{b}, and I_{c} may be respectively controlled in a manner that is not necessarily sinusoidal and does not necessarily linearly track the corresponding phase voltages Va, Vb, and Vc during a given macro-period. Nonetheless, as described above with reference to FIGS. 5A and 5B, the respective averages of the phase currents Iₐ, I_{b}, and I_{c} may be controlled such that the filtered phase currents I_{a_fil}, I_{b_fil}, and I_{c_fil} are in turn sinusoidal. However, because the underlying phase currents Ia, Ib, and Ic may be individually controlled and thereby decoupled from linearly tracking the line voltage, the underlying phase currents Iₐ, I_{b}, and I_{c} may be controlled such that the filtered phase currents I_{a_fil}, I_{b_fil}, and I_{c_fil} are sinusoidal and balanced even under conditions such as shown in FIG. 6A where the corresponding phase voltages Va, Vb, and Vc are unbalanced.

As described above, control circuit 110 may vary the switching patterns of three-phase matrix 120 and H-bridge based in part on whether a three-phase AC voltage or a single-phase AC voltage is present at AC voltage input 103. In response to a single-phase AC voltage across the first-phase input 103a and the second-phase input 103b of AC voltage input 103, control circuit 110 may be configured to apply a single-phase switching pattern that operates third phase 150 as a T-type switch in conjunction with switching of first phase 130 and second phase 140 of three-phase matrix bridge 120. By operating third phase 150 as a T-type switch, the single-phase switching pattern may apply any of five potential voltage levels across primary winding 160p of transformer 160. The operation of power converter 100 under conditions with a single-phase AC input is described in further detail below with reference to FIGS. 7A-7B and 8B.

FIG. 7A illustrates a simplified schematic diagram of power converter 100 during a discrete period of operation in accordance with embodiments of the present disclosure. Specifically, FIG. 7A illustrates a simplified schematic diagram of power converter 100 during a period whereby a single-phase AC voltage (V_{AC}) applied across first-phase input 103a and second-phase input 103b is positive.

Because V_{AC} is positive throughout a period corresponding to FIG. 7A, first transistor 131n of first bidirectional switch 131 and first transistor 132n of second bidirectional switch 132 within first phase 130 may be held in respective on-states throughout the period whereby V_{AC} is positive to save switching losses as those transistors are not needed to selectively block or pass the positive voltage level of V_{AC}. Second transistor 141p of first bidirectional switch 141 and second transistor 142p of second bidirectional switch 142 within second phase 140 may also be held in respective on-states throughout the period during which V_{AC} is positive to save switching losses.

Under the above described conditions during the period in which V_{AC} is positive, the schematic diagram of power converter 100 may be simplified as shown in FIG. 7A. For example, the second transistors 131p and 132p of first phase 130 (also labeled as PHASE A), combined with first transistors 141n and 142n of second phase 140 (also labeled as PHASE B), may form a simple H-bridge capable of applying the differential of V_{AC} to neutral across the primary winding 160p of transformer 160 (and inductance 155). Given the open state of third-phase input 103c (shown in FIG. 1B), capacitors Cₐ and C_{b} may effectively form a capacitive voltage divider that provides a one-half AC input voltage (1/2 V_{AC}) to the first bidirectional switch 151 and the second bidirectional switch 152 of third phase 150 (also labeled as PHASE C). Further, the single-phase switching pattern applied by control circuit 110 in response to the single-phase AC voltage may operate third phase 150 as a T-type switch in conjunction with the switching of first phase 130 and second phase 140. Accordingly, the single-phase switching pattern may apply any of five potential voltage levels across primary winding 160p of the transformer 160, wherein the five potential voltage levels include a first voltage level equal to the single-phase AC voltage (V_{AC}), a second voltage level equal to one-half of the single-phase AC voltage (1/2 V_{AC}), a third voltage level equal to zero, a fourth voltage level equal to a negative one-half of the single-phase AC voltage (-1/2 V_{AC}), and a fifth voltage level equal to a negative of the single-phase AC voltage (-V_{AC}).

FIG. 7B illustrates a table listing control signal states for three-phase matrix bridge 120 to apply five levels of voltages during operation with a single-phase AC supply in accordance with embodiments of the present disclosure. Specifically, FIG. 7B illustrates the five potential voltage levels that may be applied across primary winding 160p of transformer 160 (and inductance 155) by three-phase matrix bridge 120 when controlled by control circuit 110 according to the single-phase switching pattern described above. For illustrative purposes, FIG. 7B assumes V_{AC} is positive, corresponding to the simplified schematic diagram of FIG. 7A. It is appreciated however that similar control may be exercised by control circuit 110 under conditions whereby V_{AC} is negative by alternating the control of the respective first and second back-to-back transistors within each of bidirectional switch of first phase 130, second phase 140, and third phase 150.

To apply a positive V_{AC} across primary winding 160p, control circuit 110 may assert control signals A1P and B2N to turn on second transistor 131p of first bidirectional switch 131 of first phase 130, and first transistor 142n of second bidirectional switch 142 of second phase 140.

To apply a positive one-half of V_{AC} (1/2 V_{AC}) across primary winding 160p, control circuit 110 may assert control signals A1P, C2P, and C2N, to turn on second transistor 131p of first bidirectional switch 131 of first phase 130 as well as first transistor 152n and second transistor 152p of second bidirectional switch 152 of third phase 150.

To apply a zero voltage across primary winding 160p, control circuit may assert any of three potential sets of control signals to couple the same node to both the first terminal 161 and the second terminal 162 of primary winding 160p. For example, to apply zero volts across the primary winding 160p, control circuit 110 may (i) assert A1P and A2P to turn on both second transistor 131p of first bidirectional switch 131 and second transistor 132p of second bidirectional switch 132 of first phase 130, (ii) assert B1N and B2N to turn on both first transistor 141n of first bidirectional switch 141 and first transistor 142n of second bidirectional switch 142 of second phase 140, or (iii) assert C1P, C1N, C2P, and C2N to turn on each of the transistors of the first bidirectional switch 151 and the second bidirectional switch 152 of third phase 150.

To apply a negative one-half of V_{AC} (-1/2 V_{AC}) across primary winding 160p, control circuit 110 may assert control signals A2P, C1P, and C1N, to turn on second transistor 132p of second bidirectional switch 132 of first phase 130 as well as first transistor 151n and second transistor 151p of first bidirectional switch 151 of third phase 150.

To apply a negative V_{AC} across primary winding 160p, control circuit 110 may assert control signals A2P and B1N to turn on second transistor 132p of second bidirectional switch 132 of first phase 130, and first transistor 141n of first bidirectional switch 141 of second phase 140.

FIG. 8A illustrates a modulation-scheme map for operation of power converter 100 with a three-phase AC supply in accordance with embodiments of the present disclosure.

As described above with reference to FIGS. 2-4, control circuit 110 may apply a time-multiplexed switching pattern in response to a three-phase AC supply at AC voltage input 103. The time-multiplexed switching pattern may alternate between a selected two of (i) a first two-phase switching pattern that comprises switching first phase 130 and second phase 140 of the three-phase matrix bridge 120 while disabling third phase 150, (ii) a second two-phase switching pattern that comprises switching first phase 130 and third phase 150 of the three-phase matrix bridge 120 while disabling second phase 140, and (iii) a third two-phase switching pattern that comprises switching second phase 140 and third phase 150 of the three-phase matrix bridge 120 while disabling first phase 130.

In accordance with FIG. 8A, control circuit 110 may be configured to select one of a plurality of modulation schemes for each of the selected two of the of the first two-phase switching pattern, the second two-phase switching pattern, and the third two-phase switching pattern, based at least in part on a first phase voltage (Va), a second phase voltage (Vb), and a third phase voltage (Vc) at AC voltage input 103. The phase-to-phase voltage along the x-axis of FIG. 8A may represent the delta between the two phases that are switched during any given micro-period. For example, the phase-to-phase voltage in FIG. 8A may represent potential conditions for the delta between the first phase voltage (Va) and the second phase voltage (Vb) during first micro-period 311 when first phase 130 and second phase 140 are switched by control circuit 110. Likewise, the phase-to-phase voltage in FIG. 8A may represent potential conditions for the delta between the first phase voltage (Va) and the third phase voltage (Vc) during second micro-period 312 when first phase 130 and third phase 150 are switched by control circuit 110.

The modulation-scheme map in FIG. 8A may provide for selection of an optimal modulation scheme to limit RMS current through transformer 160 for a given set of voltage and current conditions. For example, in accordance with FIG. 8A, and depending on the voltage and current conditions during any given micro-period, control circuit 110 may select a modulation scheme from among a plurality of modulation schemes including a triangular boost modulation scheme 811, a triangular buck modulation scheme 812, a trapezoidal modulation scheme 813, an extended phase shift modulation scheme 814, and a single phase shift modulation scheme 815.

FIG. 8B illustrates a modulation-scheme map for operation of power converter 100 with a single-phase AC supply in accordance with embodiments of the present disclosure.

As described above with reference to FIGS. 7A-7B, control circuit 110 may apply a single-phase switching pattern in response to a single-phase AC voltage across the first-phase input 103a and the second-phase input 103b of AC voltage input 103. The single-phase switching pattern may operate third phase 150 as a T-type switch in conjunction with switching of first phase 130 and second phase 140 of three-phase matrix bridge 120. By operating third phase 150 as a T-type switch, the single-phase switching pattern may apply any of the five potential voltage levels shown in FIG. 7B across primary winding 160p of transformer 160, including, zero, positive and negative V_{AC}, and positive and negative one-half V_{AC}.

The modulation-scheme map in FIG. 8B may provide for selection of an optimal modulation scheme to limit RMS current through transformer 160 for a given set of voltage and current conditions. For example, in accordance with FIG. 8B, and depending on the voltage and current conditions during any given period, control circuit 110 may select a modulation scheme from among a plurality of modulation schemes. The plurality of modulation schemes may include various full-voltage modulation schemes, including for example a triangular boost modulation scheme 811, a triangular buck modulation scheme 812, a trapezoidal modulation scheme 813, an extended phase shift modulation scheme 814, and a single phase shift modulation scheme 815 similar to those shown in FIG. 8A. Given the availability of one-half V_{AC} voltages due to the operation of third phase 150 as a T-type switch, control circuit 110 may also select one of a plurality of half-voltage modulation schemes to apply with the single-phase switching pattern based at least in part on a voltage level of the single-phase AC voltage. For example, in accordance with FIG. 8B, and depending on the voltage and current conditions during any given period, control circuit 110 may select a modulation scheme to apply with the single-phase switching pattern from among a plurality of half-voltage modulation schemes including a half-voltage triangular boost modulation scheme 821, a half-voltage triangular buck modulation scheme 822, a half-voltage trapezoidal modulation scheme, and a half-voltage single phase shift modulation scheme 825.

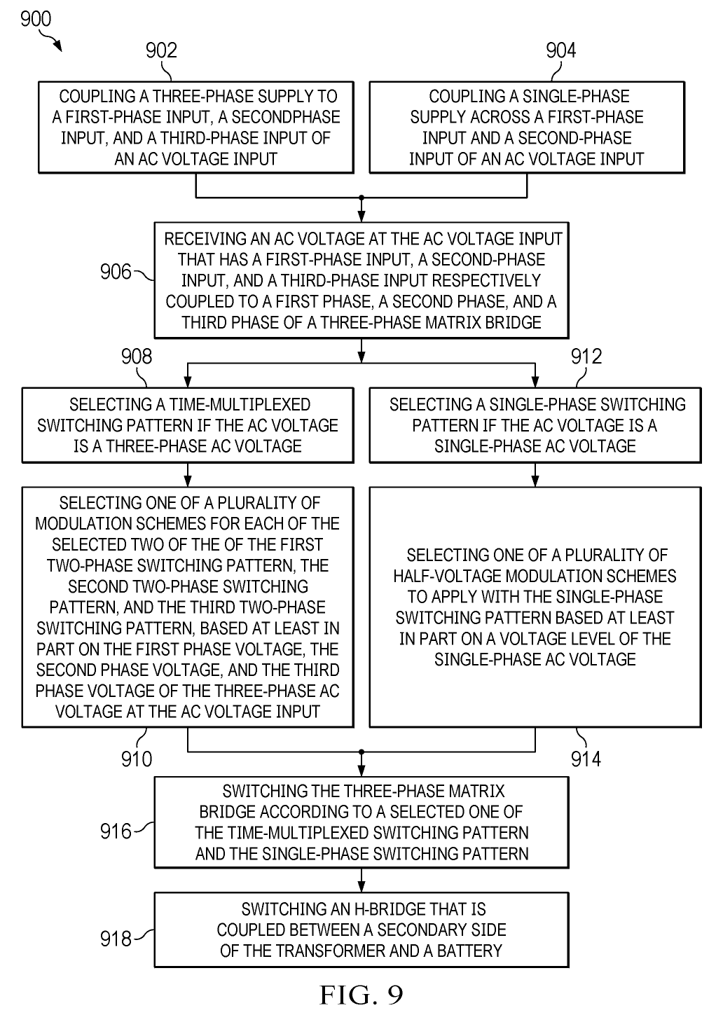

FIG. 9 illustrates an example method 900 of operating a power converter in accordance with embodiments of the present disclosure. Method 900 may be performed by any suitable mechanism, such as control circuit 110 and/or power converter 100, and/or any suitable combination of the components included therein. Method 900 may be performed with fewer or more steps than shown in FIG. 9. Moreover, steps of method 900 may be omitted, repeated, performed in parallel, performed in a different order than shown in FIG. 9, or performed recursively. One or more steps of method 900, although shown in an order, may be performed at the same time or in a re-ordered manner.

Method 900 may in some embodiments commence with one of step 902 or step 904 and then proceed to step 906.

Step 902 may include coupling a three-phase supply to the first-phase input, the second-phase input, and the third-phase input of the AC voltage input. For example, as described above with reference to FIG. 1A, AC voltage input 103 may be coupled to receive a three-phase AC voltage from three-phase AC supply 101. In some embodiments, three-phase AC supply 101 may represent a three-phase grid supply, for example as commonly available in Europe and/or China.

Step 904 may include coupling a single-phase supply across the first-phase input and the second-phase input of the AC voltage input. For example, as described above with reference to FIG. 1B, AC voltage input 103 may be coupled to receive a single-phase AC voltage (V_{AC}) from single-phase AC supply 102. In some embodiments, single-phase AC supply 102 may represent a single-phase grid supply, for example as commonly available in the United States. In some embodiments, AC voltage input 103 may be coupled to receive a single-phase AC voltage V_{AC} across the first-phase input 103aand the second-phase input 103b, while the third-phase input 103cis left open.

Step 906 may include receiving an AC voltage at the AC voltage input that has a first-phase input, a second-phase input, and a third-phase input respectively coupled to a first phase, a second phase, and a third phase of a three-phase matrix bridge. For example, as described above with reference to FIGS. 1A-1C, AC voltage input 103 may include a first-phase input 103a, a second-phase input 103b, a third-phase input 103c respectively coupled to first phase 130, second phase 140, and third phase 150 of three-phase matrix bridge 120. And as described above, AC voltage input 103 may receive an AC voltage in the form of either a three-phase AC voltage from three-phase AC supply 101 or a single-phase AC voltage from single-phase AC supply 102.

Method 900 may proceed to either steps 908 and 910 or steps 912 and 914 depending on whether the AC voltage is a three-phase AC voltage or a single-phase AC voltage.

Step 908 may include selecting a time-multiplexed switching pattern if the AC voltage is a three-phase AC voltage. As described above with reference to FIGS. 2-4, the time-multiplexed switching pattern may alternate between a selected two of (i) a first two-phase switching pattern that comprises switching first phase 130 and second phase 140 of the three-phase matrix bridge 120 while disabling third phase 150 of three-phase matrix bridge 120, (ii) a second two-phase switching pattern that comprises switching first phase 130 and third phase 150 of three-phase matrix bridge 120 while disabling second phase 140 of three-phase matrix bridge 120, and (iii) a third two-phase switching pattern that comprises switching second phase 140 and third phase 150 of three-phase matrix bridge 120 while disabling first phase 130 of three-phase matrix bridge 120. Further, as described above with reference to FIGS. 2-4, control circuit 110 may determine the selected two of the first two-phase switching pattern, the second two-phase switching pattern, and the third two-phase switching pattern based at least in part on a first phase voltage (Va for example), a second phase voltage (Vb for example), and a third phase voltage (Vc for example) of the three-phase AC voltage at AC voltage input 103.

Step 910 may in turn include selecting one of a plurality of modulation schemes for each of the selected two of the of the first two-phase switching pattern, the second two-phase switching pattern, and the third two-phase switching pattern, based at least in part on the first phase voltage, the second phase voltage, and the third phase voltage of the three-phase AC voltage at the AC voltage input. For example, as described above, the modulation scheme employed by each of the selected two of the first, second, and third two-phase switching patterns may be determined based in part on the level of the corresponding phase voltages (Va, Vb, and Vc) across a given macro-period and the alternating micro-periods therein. For example, the pulse-widths of the voltages applied across the primary winding and the secondary winding (and the currents induced as a result thereof) for each micro-period may be controlled based on the corresponding two phase voltages (the corresponding two of Va, Vb, and Vc) for that micro-period. The modulation scheme for each micro-period may thus be optimized for the specific line to line voltage and current for the corresponding phases.

Step 912 may include selecting a single-phase switching pattern if the AC voltage is a single-phase AC voltage, wherein the single-phase switching pattern is configured to operate the third phase as a T-type switch in conjunction with switching of the first phase and the second phase. For example, as described above with reference to FIGS. 7A and 7B, in response to a single-phase AC voltage across the first-phase input 103a and the second-phase input 103b of AC voltage input 103, control circuit 110 may be configured to apply a single-phase switching pattern that operates third phase 150 as a T-type switch in conjunction with switching of first phase 130 and second phase 140 of three-phase matrix bridge 120.

Step 914 may include selecting one of a plurality of half-voltage modulation schemes to apply with the single-phase switching pattern based at least in part on a voltage level of the single-phase AC voltage. For example, as described above, operating third phase 150 as a T-type switch may allow control circuit 110 to control three-phase matrix bridge 120 to apply full or half-voltages of the single-phase AC voltage (V_{AC}) across the primary side of transformer 160. Accordingly, control circuit 110 may select one of a plurality of half-voltage modulation schemes (such as a half-voltage triangular boost modulation scheme 821, a half-voltage triangular buck modulation scheme 822, a half-voltage trapezoidal modulation scheme 823, or a half-voltage single phase shift modulation scheme 825) described above with reference to FIG. 8B for example.

Step 916 may include switching the three-phase matrix bridge according to a selected one of the time-multiplexed switching pattern and the single-phase switching pattern. And step 918 may include switching an H-bridge that is coupled between a secondary side of the transformer and a battery. For example, as described above, control circuit 110 may output various control signals to control the switching of the transistors that comprise three-phase matrix bridge 120 and H-bridge 170 according to the selected switching pattern (either the time-multiplexed switching pattern or the single-phase switching pattern) and the selected modulation scheme to be applied with the selected switching pattern.

Although examples have been described above, other modifications and variations may be made from this disclosure without departing from the spirit and scope of these examples. The above descriptions of various embodiments illustrate the principles of the invention. Numerous variations and modifications will become apparent to those skilled in the art based on the above disclosure. The following claims are intended to embrace all such variations and modifications.

1. A power converter comprising:
a transformer;
an H-bridge coupled between a secondary side of the transformer and a battery;
a three-phase matrix bridge coupled between an AC voltage input and a primary side of the transformer, the three-phase matrix bridge including a first phase, a second phase, and a third phase coupled respectively between the primary side of the transformer and a corresponding one of a first-phase input, a second-phase input, and a third-phase input of the AC voltage input; and
a control circuit coupled to control switching of the three-phase matrix bridge and the H-bridge, the control circuit configured to:
in response to a three-phase AC voltage at the first-phase input, the second-phase input, and the third-phase input of the AC voltage input, apply a time-multiplexed switching pattern to switch the three-phase matrix bridge; and
in response to a single-phase AC voltage across the first-phase input and the second-phase input of the AC voltage input, apply a single-phase switching pattern that operates the third phase as a T-type switch in conjunction with switching of the first phase and the second phase of the three-phase matrix bridge.

2. The power converter of claim 1, wherein the single-phase switching pattern is configured to apply any of a five potential voltage levels across a primary winding of the transformer.

3. The power converter of claim 2, wherein the five potential voltage levels include a first voltage level equal to the single-phase AC voltage, a second voltage level equal to one-half of the single-phase AC voltage, a third voltage level equal to zero, a fourth voltage level equal to a negative one-half of the single-phase AC voltage, and a fifth voltage level equal to a negative of the single-phase AC voltage.

4. The power converter of claim 1, wherein the control circuit is configured to select one of a plurality of half-voltage modulation schemes to apply with the single-phase switching pattern based at least in part on a voltage level of the single-phase AC voltage.

5. The power converter of claim 1, wherein the time-multiplexed switching pattern alternates between a selected two of:
a first two-phase switching pattern that comprises switching the first phase and the second phase of the three-phase matrix bridge while disabling the third phase of the three-phase matrix bridge;
a second two-phase switching pattern that comprises switching the first phase and the third phase of the three-phase matrix bridge while disabling the second phase of the three-phase matrix bridge; and
a third two-phase switching pattern that comprises switching the second phase and the third phase of the three-phase matrix bridge while disabling the first phase of the three-phase matrix bridge.

6. The power converter of claim 5, wherein the control circuit is configured to determine the selected two of the first two-phase switching pattern, the second two-phase switching pattern, and the third two-phase switching pattern based at least in part on a first phase voltage, a second phase voltage, and a third phase voltage at the AC voltage input.

7. The power converter of claim 5, wherein the control circuit is configured to select one of a plurality of modulation schemes for each of the selected two of the of the first two-phase switching pattern, the second two-phase switching pattern, and the third two-phase switching pattern, based at least in part on a first phase voltage, a second phase voltage, and a third phase voltage at the AC voltage input.

8. The power converter of claim 1, wherein the control circuit is configured to detect whether the three-phase AC voltage or the single-phase AC voltage is present at the AC voltage input.

9. The power converter of claim 1, wherein:
the first phase of the three-phase matrix bridge is configured as a first bidirectional half-bridge between the first-phase input and the primary side of the transformer;
the second phase of the three-phase matrix bridge is configured as a second bidirectional half-bridge between the first-phase input and the primary side of the transformer; and
the third phase of the three-phase matrix bridge is configured as a third bidirectional half-bridge between the first-phase input and the primary side of the transformer.

10. The power converter of claim 1, wherein the H-bridge comprises:
a first switch coupled between a first terminal of a secondary winding of the transformer and a first terminal of the battery;
a second switch coupled between the first terminal of the secondary winding of the transformer and a second terminal of the battery;
a third switch coupled between a second terminal of the secondary winding of the transformer and the first terminal of the battery; and
a fourth switch coupled between the second terminal of the secondary winding of the transformer and the second terminal of the battery.

11. A three-phase matrix dual active bridge power converter comprising:
a transformer;
an H-bridge coupled between a secondary side of the transformer and a battery;
a three-phase matrix bridge including:
a first phase configured as a first bidirectional half-bridge between a first-phase input of an AC voltage input and a primary side of the transformer;
a second phase configured as a second bidirectional half-bridge between a second-phase input of the AC voltage input and the primary side of the transformer; and
a third phase configured as a third bidirectional half-bridge between a third-phase input of the AC voltage input and the primary side of the transformer; and
a control circuit coupled to control switching of the three-phase matrix bridge and the H-bridge, the control circuit configured to:
detect whether a three-phase AC voltage is present at the AC voltage input or a single-phase AC voltage is present across the first-phase input and the second-phase input of the AC voltage input;
in response to the three-phase AC voltage at the first-phase input, the second-phase input, and the third-phase input of the AC voltage input, apply a time-multiplexed switching pattern to switch the three-phase matrix bridge; and
in response to the single-phase AC voltage across the first-phase input and the second-phase input of the AC voltage input, apply a single-phase switching pattern that operates the third phase as a T-type switch in conjunction with switching of the first phase and the second phase of the three-phase matrix bridge.

12. The three-phase matrix dual active bridge power converter of claim 11, wherein the single-phase switching pattern is configured to apply any of five potential voltage levels across a primary winding of the transformer, the five potential voltage levels including a first voltage level equal to the single-phase AC voltage, a second voltage level equal to one-half of the single-phase AC voltage, a third voltage level equal to zero, a fourth voltage level equal to a negative one-half of the single-phase AC voltage, and a fifth voltage level equal to a negative of the single-phase AC voltage.

13. A method of operating a three-phase matrix dual active bridge power converter, comprising:
receiving an AC voltage at an AC voltage input that has a first-phase input, a second-phase input, and a third-phase input respectively coupled to a first phase, a second phase, and a third phase of a three-phase matrix bridge;
selecting a time-multiplexed switching pattern if the AC voltage is a three-phase AC voltage;
selecting a single-phase switching pattern if the AC voltage is a single-phase AC voltage, wherein the single-phase switching pattern is configured to operate the third phase as a T-type switch in conjunction with switching of the first phase and the second phase;
switching the three-phase matrix bridge according to a selected one of the time-multiplexed switching pattern and the single-phase switching pattern; and
switching an H-bridge that is coupled between a secondary side of a transformer and a battery.

14. The method of claim 13, wherein the single-phase switching pattern is configured to apply any of five potential voltage levels across a primary winding of the transformer, the five potential voltage levels including a first voltage level equal to the single-phase AC voltage, a second voltage level equal to one-half of the single-phase AC voltage, a third voltage level equal to zero, a fourth voltage level equal to a negative one-half of the single-phase AC voltage, and a fifth voltage level equal to a negative of the single-phase AC voltage.

15. The method of claim 13, further comprising selecting one of a plurality of half-voltage modulation schemes to apply with the single-phase switching pattern based at least in part on a voltage level of the single-phase AC voltage.

16. The method of claim 13, wherein the time-multiplexed switching pattern alternates between a selected two of:
a first two-phase switching pattern that comprises switching the first phase and the second phase of the three-phase matrix bridge while disabling the third phase of the three-phase matrix bridge;
a second two-phase switching pattern that comprises switching the first phase and the third phase of the three-phase matrix bridge while disabling the second phase of the three-phase matrix bridge; and
a third two-phase switching pattern that comprises switching the second phase and the third phase of the three-phase matrix bridge while disabling the first phase of the three-phase matrix bridge.

17. The method of claim 16, further comprising determining the selected two of the first two-phase switching pattern, the second two-phase switching pattern, and the third two-phase switching pattern based at least in part on a first phase voltage, a second phase voltage, and a third phase voltage of the three-phase AC voltage at the AC voltage input.

18. The method of claim 16, further comprising selecting one of a plurality of modulation schemes for each of the selected two of the of the first two-phase switching pattern, the second two-phase switching pattern, and the third two-phase switching pattern, based at least in part on the first phase voltage, the second phase voltage, and the third phase voltage of the three-phase AC voltage at the AC voltage input.

19. The method of claim 13, further comprising coupling a three-phase supply to the first-phase input, the second-phase input, and the third-phase input of the AC voltage input.

20. The method of claim 13, further comprising coupling a single-phase supply across the first-phase input and the second-phase input of the AC voltage input.
